(19) United States
(12) Patent Application Publication
(10) Pub. No.: US 2016/0189155 A1
(43) Pub. Date: Jun. 30, 2016

(54) Transaction Information Processing Method and Apparatus

(71) Applicant: Alibaba Group Holding Limited, Grand Cayman (KY)

(72) Inventors: Guanghui Hu, Hangzhou (CN); Chenlv Wu, Hangzhou (CN); Zhi Kong, Hangzhou (CN); Ming Zhang, Hangzhou (CN)

(21) Appl. No.: 14/976,795

(22) Filed: Dec. 21, 2015

(30) Foreign Application Priority Data
Dec. 24, 2014 (CN) 201410817824.8

(51) Int. Cl. G06Q 20/40

(52) U.S. Cl. CPC G06Q 20/405; G06Q 20/407

(57) ABSTRACT

A method and an apparatus of processing transaction information are disclosed. The method includes receiving a transaction instruction from a user account; generating corresponding transaction information according to the transaction instruction; sending the transaction information to a transaction account that is bound to the user account in advance; processing the transaction information through the transaction account; and sending the processed transaction information to the user account through the transaction account. By setting up a transaction account to bind with a user account, even though the user account is not capable of receiving transaction information in an international business scenario, the transaction information can be received by the user account through the transaction account, thus effectively solving a problem that certain user accounts cannot directly receive transaction information in an international business scenario and improving an efficiency of processing transaction information.

### CROSS REFERENCE TO RELATED PATENT APPLICATION

This application claims foreign priority to Chinese Patent Application No. 201410817824.8 filed on Dec. 24, 2014, entitled “Transaction Information Processing Method and Apparatus”, which is hereby incorporated by reference in its entirety.

### TECHNICAL FIELD

The present disclosure relates to the field of computer technologies, and particularly, to transaction information processing methods and apparatuses.

### BACKGROUND

With the development of information technologies, the Internet has provided a wealth of network resources to users, and the users can conveniently obtain various types of transaction services by registering user accounts.

In existing technologies, an approach via which a user usually obtains a transaction service includes a user sending a transaction instruction to a corresponding server via a user account thereof, and the server returning corresponding transaction information to the user account according to the transaction instruction upon receiving the transaction instruction sent by the user account, so that the user is able to obtain the transaction service. Especially, because of the trend of internationalization of transaction services nowadays, users in different countries and regions can obtain various types of transaction services from the same website, such as online transaction, video subscription and information query, etc.

However, under an international business environment, due to differences among countries and regions, users may obtain transaction services via different ways. In order to guarantee that transaction information can be delivered to a corresponding user account, a server can only return the transaction information through a channel via which an associated transaction instruction is sent. If the channel via which the transaction instruction is sent is not capable of receiving the transaction information, an associated user cannot receive the corresponding transaction information.

For example, in an international payment scenario, when a user requests a refund for a commodity purchased thereby, the user sends a refund request instruction to a server through his/her user account. According to the user′ refund request instruction, the server returns refund information to the user via a payment mode (i.e., the payment mode is a channel via which a transaction instruction is submitted) used by the user when purchasing commodity. However, the user′ payment mode may be a direct payment made through a registered user account of the user. Due to different requirements for network payment among countries and regions, certain countries and regions do not allow virtual accounts such as the user account registered by the user to receive a refund from the server directly, and such a refund can only be received through a bank account. As a result, the refund information is not returned to the user account, and the user cannot receive the refund.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or computer-readable instructions as permitted by the context above and throughout the present disclosure.

Embodiments of the present disclosure provide a method and an apparatus of processing transaction information, to solve a problem of a low efficiency of a transaction service in an international business environment nowadays.

In an embodiment, the present disclosure provides a transaction information processing method, which includes receiving a transaction instruction from a user account and generating corresponding transaction information according to the transaction instruction; sending the transaction information to a transaction account that is bound to the user account in advance and processing the transaction information through the transaction account; and sending the processed transaction information to the user account through the transaction account.

In an embodiment, the present disclosure provides a transaction information processing apparatus, which includes:

a generation module used for receiving a transaction instruction from a user account and generating corresponding transaction information according to the transaction instruction; a transaction account module used for sending the transaction information to a transaction account that is bound to the user account in advance and processing the transaction information through the transaction account; and a sending module used for sending the processed transaction information to the user account through the transaction account.

The embodiments of the present disclosure provide a method and an apparatus of processing transaction information. By setting a transaction account that is bound to a user account, a server may send transaction information corresponding to a transaction instruction to the transaction account for corresponding processing after a user submits the corresponding transaction instruction via the user account, and send the processed transaction information to the user account through the transaction account, instead of directly sending to the user account. As such, even if the user account is not capable of receiving the transaction information in an international business scenario, the transaction information can be received through the transaction account and then sent to the user account. This effectively solves the problem that a user account cannot directly receive transaction information in an international business scenario and improves the efficiency of processing the transaction information.

### BRIEF DESCRIPTION OF THE DRAWINGS

Drawings described herein are used for providing a further understanding of the present disclosure, and constitute a part of the present disclosure. Exemplary embodiments of the present disclosure and description thereof are used for illustrating the present disclosure and are not to be construed as an improper limitation on the present disclosure. In the drawings,

FIG. 1 shows a process of processing transaction information in accordance with an embodiment of the present disclosure.

FIG. 2 shows a structural diagram of an apparatus of processing transaction information in accordance with an embodiment of the present disclosure.

### DETAILED DESCRIPTION

In order to make the objectives, technical solutions, and advantages of the present disclosure more comprehensible, the technical solutions of the present disclosure are clearly and fully described herein with reference to exemplary embodiments and corresponding accompanying drawings of the present disclosure. Apparently, the described embodiments are merely a part of and not all of the embodiments of the present disclosure. All other embodiments obtained by one of ordinary skill in the art based on the embodiments of the present disclosure without making any creative effort shall belong to the scope of protection of the present disclosure.

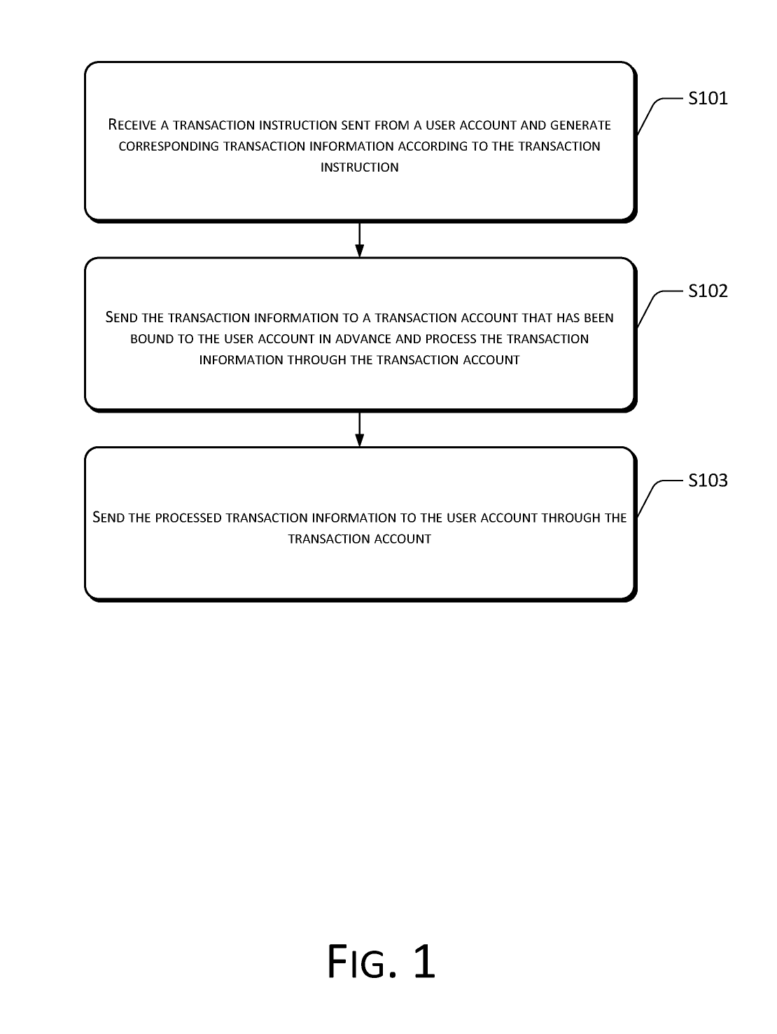

FIG. 1 shows a process of processing transaction information according to an embodiment of the present disclosure. The process may include method blocks as described in the following.

S101 receives a transaction instruction sent from a user account and generates corresponding transaction information according to the transaction instruction.

In an implementation of the present disclosure, when a user wants to obtain a transaction service and submits a transaction instruction via a user account thereof, a corresponding server may receive the transaction instruction and generate corresponding transaction information according to the transaction instruction.

In an implementation, the user account may include a personal account registered in advance by the user in the server. The transaction instruction may include an instruction submitted by the user through his user account to the server for obtaining the transaction service, such as a refund instruction, etc. The transaction information may include result information of the transaction service generated by the server according to the transaction instruction, such as refund information, etc.

For example, a Chinese user A registers a personal account with a username userA in a certain website, and the personal account userA is a user account of the user A. After the user A uses his/her user account userA to buy a commodity on the website, the user A may want to perform a refund transaction due to a quality problem of the commodity. The user A may then submit a refund instruction through his/her user account userA. A server of the website may generate corresponding refund information according to the refund instruction. At this moment, the refund instruction is a transaction instruction, and the refund information is transaction information. Apparently, in an implementation of the present disclosure, after the user account receives the refund information, an amount of fund in the user account may change immediately. Specifically, an amount of funds in the refund information is added to the amount of fund in the user account immediately, and a receipt of the refund information indicates that the refund transaction is successful.

It is noted that, when a user uses his/her user account to submit a transaction instruction, such as a refund instruction, the server may query detailed information of a transaction service operation corresponding to the refund instruction according to the refund instruction, which includes information such as an amount of payment, a payment channel, etc. The server may generate corresponding transaction information, i.e., refund information, according to these pieces of information that are found. Therefore, in an implementation of the present disclosure, the transaction information includes a payment channel and/or a refund amount.

S102 sends the transaction information to a transaction account that has been bound to the user account in advance and processes the transaction information through the transaction account.

Following the above example, a payment channel for the user A to purchase the commodity (the payment channel described in this example refers to a channel used by the user A to make a payment to a seller of the commodity) is assumed as making a payment directly from a balance that is deposited in advance in his/her user account userA. In this case, when the server carries out the refund transaction for the user A, a corresponding payment channel (the payment channel described in this example refers to a channel used by the server to make a refund to the user A) is sending an amount of payment that has been made by the user A from the server to the user account userA of the user A. However, in an international transaction service scenario under existing technologies, regulations in some countries and regions do not allow a server to directly send refund information to a user account. As such, the server cannot send the refund information according to the payment channel, i.e., the server cannot directly send the refund information to the user account userA.

Therefore, in order to solve the problem that a payment channel is not able to receive transaction information, in an implementation of the present disclosure, the transaction information that is generated by the server is received by setting a corresponding transaction account.

In an implementation of the present disclosure, the transaction amount may include a non-personal account which is allowed to receive transaction information, such as an enterprise account. Apparently, in an implementation of the present disclosure, the transaction account is also registered in advance in the server. For example, a transaction account, China-user, with a country to which the account belongs as China may be registered in the website. The transaction account China-user is bound with the user account userA in advance, and the server may send the corresponding refund information to the transaction account China-user.

It is noted that, after the server sends the transaction information including the refund amount to the transaction account, an amount value in the transaction account may not change immediately. This is because the refund amount included in the transaction information is merely a kind of character-type information that reflects a numerical value of the refund amount for the server. During a process of refund operation performed by the user, a change in the amount value is actually a change in the deposit of a corresponding bank account. In other words, when the server processes the refund operation, the server needs to interact with a bank system (such as a bank server). The server changes the numerical value of the amount value in the user account only after the bank system records the amount corresponding to the refund operation.

According to the above analysis, after the server sends the transaction information to the transaction account, processing the transaction information through the transaction account at S102 may include the transaction account interacting with a corresponding bank system according to the refund amount in the transaction information to cause the bank system to record the refund amount, i.e., the bank system records the refund amount in the bank account corresponding to the user account (such as a bank card that is bound to the user account).

For instance, in response to receiving the refund amount for the user account userA in the above example, the transaction account China-user may interact with a bank system corresponding to the user account userA to cause the bank system to record the refund amount in the bank account corresponding to the userA.

In addition, the server may generate different transaction information for user accounts in different countries and regions in real application scenarios. For example, if the transaction information is refund information, due to differences among currencies of different countries and regions, the server generates refund information of a corresponding currency according to a currency used by the user account for making the payment. In this case, if the user account and the transaction account bound thereto do not belong to the same country and region, the refund information is subject to a difference in exchange rate, and consequently the refund information has a problem of exchange rate fluctuation.

Thus, in an exemplary implementation of the present disclosure, after a user completes the registration of a user account, the server may bind the user account and a transaction account which belong to the same country and region automatically according to the determined country and region to which the user account and the transaction account belong. It is noted that, in an international business scenario, users come from different countries and regions. When a user registers a user account in a corresponding server, the server may determine a country and region to which a user account belongs based on an Internet Protocol (IP) address of the user. Similarly, when a transaction account is registered, the server may also determine a country and region to which the transaction account belongs based on a corresponding IP address.

Apparently, in a real application, whether to bind a user account and a transaction account automatically according to respective countries and regions that they belong can be configured according to actual needs, which does not form limitation to the present disclosure.

In an implementation of the embodiment of the present disclosure, a transaction account may be bound to a plurality of user accounts, i.e., user accounts of the same country and region can be bound to a transaction account which also belongs to such country and region. In this case, the transaction account is a public transaction account. Transaction information of each user account is temporarily stored in the public transaction account. Apparently, transaction information corresponding to different user accounts is recorded in the public transaction account, and a chaos in the transaction information does not occur.

S103 sends the processed transaction information to the user account through the transaction account.

The transaction account stores respective pieces of transaction information of different user accounts. After the above processing, the bank system has recorded refund amounts in respective bank accounts that are bound to the user accounts. In this way, the respective pieces of transaction information stored in the transaction account may be sent to the user accounts corresponding to the respective pieces of transaction information individually through the transaction account to cause corresponding numerical values of the fund amounts in different user accounts to change. A process of sending the pieces of transaction information to the user accounts from the transaction amount may be regarded as a process of interaction of information among accounts, such that the respective pieces of transaction information is effectively sent to the user accounts.

Following the above example, the server may send the refund information to the user account userA through the transaction account China-user, such that the user account userA obtains the refund from the server. A numerical value of a fund amount in the user account userA is changed, and thereby the refund transaction is completed.

Through the above method blocks, a transaction account that has permission to receive and send transaction information is registered in advance in the server. When different users register corresponding user accounts in the server, user accounts of the same country and region are bound to a transaction account which also belongs to such country and region. In this way, when the server sends a transaction instruction according to a user account and generates corresponding transaction information, the transaction information can be directly sent to the transaction account, and is then sent to a corresponding user account through the transaction account. As such, the transaction information is ensured to be delivered to the user account.

In an international transaction service scenario of a real application, when a user registers a user account, a correlation between a corresponding bank account (such as a bank card) and the user account needs to be established to facilitate operations such as making a payment in transaction services. So, when the transaction information includes a refund amount, the transaction information may be sent to a transaction account bound to the user account and is then sent to a bank account directly corresponding to the user account through the transaction account as described at S102 to S103.

Following the above example, a correlation between a bank card X used by the user and the user account userA is established, i.e., the bank card X is a bank account of the user account userA. A payment channel used by the user A to purchase a certain commodity is assumed to be making a payment by the user A using the bank card X. After the user A uses his/her user account userA to submit a refund instruction to the server, the server may send corresponding refund information to the transaction account China-user that is bound to the user account userA. The refund information may then be sent to the bank card X through the transaction account China-user according to the payment channel to complete the refund transaction.

However, different banks set up corresponding amount limits for such refund transaction. Specifically, the bank receives the transaction information only when the refund amount reaches a specified limit set by the bank, and the bank does not accept the transaction information which does not reach the specified limit. In other words, if the transaction information of the user account does not reach the specified limit set by the banks, a situation in which the transaction information cannot be sent to the bank account of the user occurs. For example, if the lowest refund amount limit of the bank to which the bank card X belongs is ten dollars, the bank will not accept for processing if the amount included in the refund information is only eight dollars, i.e., the refund operation fails.

Therefore, when the transaction information includes the refund amount, sending the processed transaction information to the user account at S103 may include determining whether the transaction information satisfies a preset condition; sending the transaction information to a bank account corresponding to the user account through the transaction account if affirmative; storing the transaction information in an information set, and sending the transaction information to the bank account corresponding to the user account when a total amount associated with all pieces of transaction information in the information set satisfies the preset condition otherwise.

In an implementation of the present disclosure, since the transaction information includes the refund amount, determining whether the transaction information satisfies the preset condition actually corresponds to determining whether the refund amount included in the transaction information is higher than the lowest refund limit (i.e., the specified limit set up by the bank). If so, this indicates that the refund amount in the transaction information is higher than or equal to the lowest refund limit set up by the bank, and a determination is made that the transaction information satisfies the preset condition. Otherwise, this indicates that the refund amount in the transaction information is lower than the lowest refund limit set up by the bank, and a determination is made that the transaction information does not satisfy the preset condition.

If the transaction information satisfies the preset condition, the transaction information may be sent to the corresponding bank account through the transaction account.

However, if the transaction information does not satisfy the preset condition, the bank account corresponding to the user account will not receive the transaction information, i.e., the transaction information cannot be sent to the bank account corresponding to the user account through the transaction account. At this point, the server can store the transaction information which does not satisfy the present condition in an information set of the transaction account.

Specifically, taking into consideration that the user may use his/her user account to obtain transaction service(s) repeatedly, the server may send corresponding transaction information to the transaction account repeatedly. Thus, after a while, a total amount associated with transaction information stored in the transaction account may satisfy the preset condition. Therefore, in an implementation of the present disclosure, storing the transaction information in the information set may include storing the transaction information in an information set corresponding to the user account. Sending the transaction information to the bank account corresponding to the user account until the total amount associated with all the pieces of the transaction information in the information set satisfies the preset condition may include sending the transaction information to the bank account corresponding to the user account in response to a sum of refund amounts included in all the pieces of the transaction information in the information set being higher than the lowest refund limit.

The above example is used for further illustration.

The user A uses the user account userA to buy the commodity from the website and uses the bank card X that is issued by the bank 1 and is bound to the user account userA to make a payment of RMB 4 Yuan. Later, due to the quality problem of the commodity, the user A submits the refund instruction via his/her user account userA. In response to receiving the refund instruction, the server sends the generated refund information to the transaction account China-user that is bound with the user account userA. The refund information includes a refund amount of RMB 4 Yuan.

At this point, the lowest refund limit that is set up by the bank 1 is assumed to be RMB 10 Yuan. Apparently, the refund amount (RMB 4 Yuan) in the refund information is lower than the lowest refund limit of the bank land thus the refund information cannot be sent to the bank card X through the transaction account China-user.

As such, the server stores the refund information in an information set corresponding to the user account userA in the transaction account China-user. The information set is used for storing all refund information of the user account userA.

After a certain period of time, the user A uses his/her user account userA to buy a commodity and pay RMB 8 Yuan. The user A submits a refund instruction to the server due to the same reason, and the server sends generated refund information to the information set corresponding to the user account userA in the transaction account China-user. At this point, a total amount associated with the refund amounts of the refund information is RMB 12 Yuan, which is higher than the lowest refund limit of the bank 1. Accordingly, the server sends refund information having a refund amount of RMB 12 Yuan to the bank card X of the user A through the transaction account China-user to complete a refund transaction.

As can be seen from the above example, the above implementation stores and accumulates transaction information of a single user account. When the transaction information of the single user account does not satisfy a preset condition, the transaction information of the user account may be stored in an information set in a transaction account. The transaction information is accumulated until a total amount of the transaction information satisfies the preset condition, and the transaction information can then be sent to the bank account corresponding to the user account to complete a refund operation.

However, in a real application, some users use their user accounts infrequently, and these users may even not use their user accounts to perform transaction service operations for a long time. Under these situations, if the above approach of storing and accumulating transaction information of a single user account is used, respective transaction information of the user accounts will be stored in an transaction account for a long time since the users may not use their user accounts for a long time, and thus cannot be sent to bank accounts corresponding to the user accounts, which severely reduces the processing efficiency of refund transactions.

Therefore, in order to improve the processing efficiency of the refund transactions, in another implementation of the present disclosure, storing the transaction information in the information set may include determining a bank type of the bank account corresponding to the user account and storing the transaction information in an information set corresponding to the determined bank type. When a sum of refund amounts included in all pieces of transaction information in the information set is higher than the lowest refund limit, the transaction information is sent to the bank account corresponding to the user account. In other words, this implementation stores and accumulates respective transaction information of a plurality of bank accounts which belong to a same bank type, thus effectively increasing the storage and accumulation efficiency of transaction information.

It is noted that the information set corresponding to the bank type includes transaction information of a plurality of user accounts (refund limits included in some transaction information satisfy the preset condition, and others may not). These pieces of transaction information are sent to corresponding bank accounts respectively. If respective transaction information of different transaction accounts are individually sent, the bank will not accept for processing because certain pieces of transaction information do not satisfy the preset condition. Thus, these pieces of transaction information can only be sent to a public bank account, and is then dispatched for processing in the bank. Therefore, in an implementation of the present disclosure, transaction account(s) is/are correlated with different bank accounts, i.e., public bank accounts, for different bank types. In this way, when the approach of storing and accumulating transaction information of a plurality of bank accounts is used, transaction information, which satisfies the preset condition, in the information set may be sent together to a public bank account, and the transaction information in the public bank account is then sent to respective bank accounts corresponding to different user accounts.

The above implementation is described hereinafter in detail using an application example.

In this application example, a user account of a user A is userA, a bank account is a bank card X, a bank type to which the bank card X belongs is a bank 1, and Chinese users B and C are added into this example. For the user B, a user account thereof is userB, a bank account is a bank card Y, a bank type to which the bank card Y belongs is a bank 2, and the lowest refund limit set by the bank 2 is RMB 8 Yuan.

For the user C, his/her user account is userC, his/her bank account is a bank card Z, and a bank type to which the bank card Z belongs is the bank 1.

Since a country to which the user accounts userB and userC belong is China, the server binds the user accounts userB and userC to a transaction account China-user.

In addition, in this application example, a public bank account that is set to be correlated with the transaction account China-user is a bank card CN1 for the bank 1, and a public bank account that is set to be correlated for the bank 2 is a bank card CN2.

An exemplary process may include the following:

Similar to the foregoing examples, the user A submits a refund instruction through the user account userA. The server sends refund information that is generated thereby to the transaction account China-user bound to the user account userA. The refund information includes a refund amount of RMB 4 Yuan.

The user B uses the user account userB to submit a refund instruction, and requests a refund amount of RMB 6 Yuan. In response to receiving the refund instruction, the server sends refund information that is generated thereby to the transaction account China-user bound to the user account userB. The refund information includes a refund amount of RMB 6 Yuan.

The user C uses his/her user account userC to submit a refund instruction, and requests a refund amount of RMB 9 Yuan. Upon receiving the refund instruction, the server sends generated refund information to the transaction account China-user bound to the user account userC. The refund information includes a refund amount of RMB 9 Yuan.

The server determines that the respective refund information of the user accounts userA, userB and userC does not satisfy the lowest refund limit set by the bank separately. Therefore, the server stores these pieces of transaction information in an information set.

At this point, the server determines that the bank type to which the bank card X corresponding to the user account userA and the bank card Z corresponding to the user account userC belong is the bank 1. The server thus stores the refund information of the user accounts userA and userC in an information set corresponding to the bank 1 in the transaction account China-user. In this case, a sum of the refund amounts included in the refund information in the information set corresponding to the bank 1 is RMB 13 Yuan, which is higher than the lowest refund limit RMB 10 Yuan set up by the bank 1. Therefore, the server may send the refund information to the bank 1, i.e., to the bank card CN1. The bank 1 may then send corresponding refund information in the bank card CN1 to the bank card X and the bank card Z respectively.

The server determines that the bank type to which the bank card Y corresponding to the user account userB is the bank 2. The server stores the refund information of the user account userB, and refund information of other user accounts (not shown in this example) bound to bank accounts which bank type belongs to the bank 2, in an information set corresponding to the bank 2 in the transaction account China-user. After a sum of refund amounts included in the refund information in the information set corresponding to the bank 2 is higher than the lowest refund limit (which is RMB 8 Yuan) set up by the bank 2, the refund information in the information set is sent together to the bank card CN2. The bank 2 then sends respective refund information in the bank card CN2 to different bank accounts individually to complete associated refund transactions.

As can be seen from the above example, the foregoing implementation jointly stores and accumulates respective the transaction information of a plurality of user accounts that are bound to bank accounts of a same bank type. Even though transaction information of a certain user account does not satisfy a preset condition, a total amount of transaction information stored in an information set can satisfy the preset condition in a short time by using this approach of joint storage and accumulation, thus effectively increasing the storage and accumulation efficiency of transaction information.

Apparently, in a real application scenario, a corresponding service charge may incur when refund information is sent to a bank account through a transaction account. So, for a user account, multiple service charges may incur if this user account has multiple pieces of refund information. According to the present implementation of the present disclosure, multiple pieces of refund information in a user account may therefore be stored and accumulated. When a sum of refund amounts included in the multiple pieces of refund information is higher than a preset value, the multiple pieces of refund information are sent together, which effectively reduces an amount of service charges incurred for refunds.

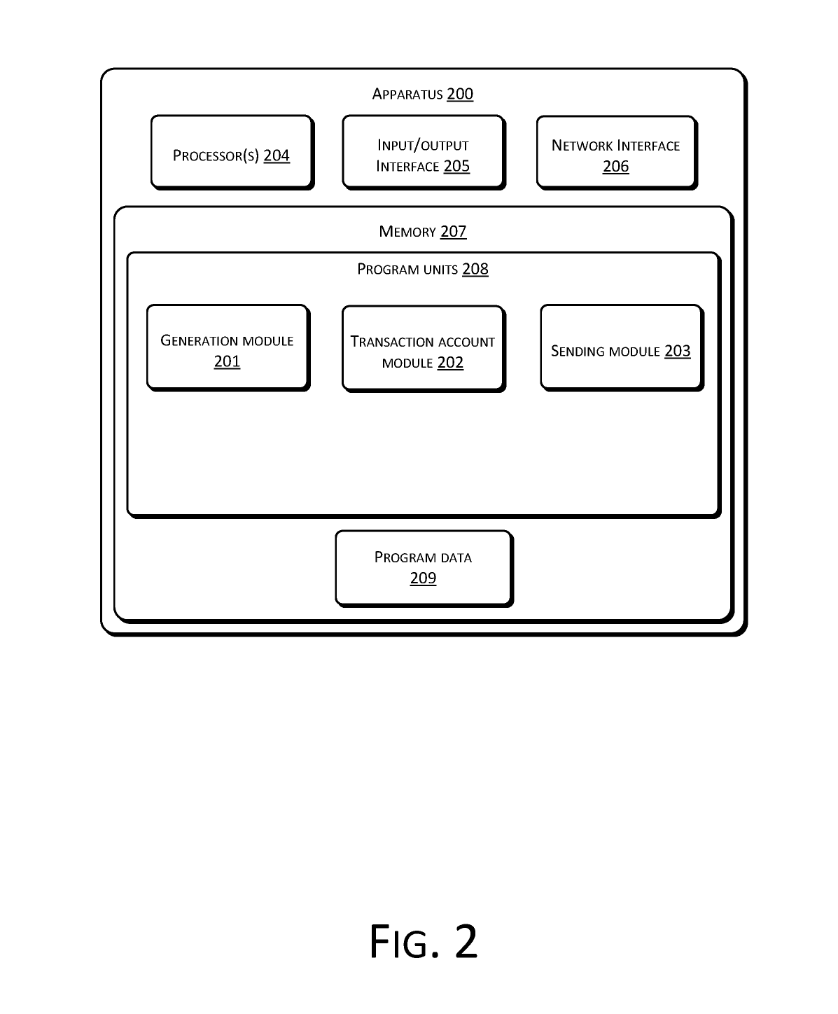

The transaction information processing method according to the embodiments of the present disclosure is described as above. Based on the same concept, the embodiments of the present disclosure further provide a transaction information processing apparatus, as shown in FIG. 2.

In FIG. 2, the transaction information processing apparatus 200 may include a generation module 201, a transaction account module 202 and a sending module 203. The generation module 201 may be used for receiving a transaction instruction submitted from a user account and generating corresponding transaction information according to the transaction instruction. The transaction account module 202 may be used for sending the transaction information to a transaction account that is bound to the user account in advance and processing the transaction information through the transaction account. The sending module 203 may be used for sending the processed transaction information to the user account through the transaction account.

In an implementation of the present disclosure, the transaction instruction may include a refund instruction, the transaction information includes refund information and the transaction information includes a payment channel and/or a refund amount.

In an implementation, if the transaction information includes a refund amount, the sending module 203 may further be used for determining whether the transaction information satisfies a preset condition; sending the transaction information to a bank account corresponding to the user account through the transaction account if affirmative; otherwise, storing the transaction information in an information set, and sending the transaction information to the bank account corresponding to the user account until a total amount of all transaction information in the information set satisfies the preset condition otherwise.

In an implementation, the sending module 203 may further be used for determining whether the refund amount included in the transaction information is higher than the lowest refund limit; determining that the transaction information satisfies the preset condition if affirmative; and determining that the transaction information does not satisfy the preset condition otherwise.

In an implementation, the sending module 203 may further be used for determining a bank type of the bank account corresponding to the user account, storing the transaction information in an information set corresponding to the determined bank type, and sending the transaction information to the bank account corresponding to the user account in response to a sum of refund amounts included in all transaction information in the information set being higher than the lowest refund limit.

In an implementation, the sending module 203 may further be used for storing the transaction information in an information set corresponding to the user account, and sending the transaction information to the bank account corresponding to the user account in response to a sum of refund limits included in all transaction information in the information set being higher than the lowest refund limit.

In a typical configuration, a computing device may include one or more Central Processing Units (CPUs), an input/output (I/O) interface, a network interface, and memory. In an implementation, the apparatus 200 may further include one or more computing devices. For example, the apparatus 200 may include, but is not limited to, one or more processors 204, an input/output (I/O) interface 205, a network interface 206 and memory 207.

The memory 207 may include a form of computer readable media, e.g., a non-permanent storage device, random-access memory (RAM) and/or a nonvolatile internal storage, such as read-only memory (ROM) or flash RAM. The memory 207 is an example of computer readable media.

The computer readable media may include a permanent or non-permanent type, a removable or non-removable media, which may achieve storage of information using any method or technology. The information may include a computer-readable command, a data structure, a program module or other data. Examples of computer storage media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer readable media does not include transitory media, such as modulated data signals and carrier waves.

The memory 207 may include program modules 208 and program data 209. The program modules 208 may include one or more of the modules described in the foregoing implementations, such as the generation module 201, the transaction account module 202 and the sending module 203.

It should also be noted that terms such as “comprise”, “include” or any other variations thereof are meant to cover the non-exclusive inclusions. The process, method, product or apparatus that includes a series of elements not only includes those elements, but also includes other elements that are not explicitly listed, or further includes elements that already existed in such process, method, product or apparatus. In a condition without further limitations, an element defined by the phrase “include a/an . . . ” does not exclude any other similar elements from existing in the process, method, product or apparatus.

One skilled in the art should understand that the embodiments of the present disclosure may be embodied as a method, a system, or a computer program product. Accordingly, the present disclosure may take a form of an embodiment of hardware only, software only, or a combination of software and hardware. Furthermore, the present disclosure may take a form of a computer program product that is implemented in one or more computer-usable storage media (which includes, but is not limited to, a magnetic disk storage, CD-ROMs, an optical storage, etc.) which include computer-usable program code.

The above descriptions are merely embodiments of the present disclosure, and are not intended to limit the present disclosure. For one skilled in the art, the present disclosure may have various types of modifications and variations. Any modifications, equivalent replacements, improvements or the like made within the spirit and principle of the present disclosure shall be included in the scope of the appended claims of the present disclosure.

What is claimed is:

1. A method implemented by one or more computing devices, the method comprising:
receiving a transaction instruction from a user account and generating corresponding transaction information according to the transaction instruction;
sending the transaction information to a transaction account that is bound to the user account in advance and processing the transaction information through the transaction account; and
sending the processed transaction information to the user account through the transaction account.

2. The method of claim 1, wherein the transaction instruction comprises a refund instruction, the transaction information comprises refund information which includes one or more of a payment channel or a refund amount.

3. The method of claim 1, wherein sending the processed transaction information to the user account comprises:
determining whether the transaction information satisfies a preset condition;
sending the transaction information to a bank account corresponding to the user account through the transaction account in response to determining that the transaction information satisfies the preset condition; and
storing the transaction information in an information set, and sending the transaction information to the bank account corresponding to the user account when a total amount that is associated with all transaction information in the information set satisfies the preset condition, in response to determining that the transaction information does not satisfy the preset condition.

4. The method of claim 3, wherein the transaction instruction comprises a request for refund, and wherein determining whether the transaction information satisfies the preset condition comprises determining whether a refund amount in the transaction information is higher than a lowest refund limit.

5. The method claim 4, wherein determining that the transaction information satisfies the preset condition in response to determining that the refund amount in the transaction information is higher than a lowest refund limit.

6. The method of claim 3, wherein storing the transaction information in the information set comprises:
determining a bank type of the bank account corresponding to the user account; and
storing the transaction information in a specified information set corresponding to the determined bank type.

7. The method of claim 6, wherein sending the transaction information to the bank account corresponding to the user account when the total amount that is associated with all the transaction information in the information set satisfies the preset condition, comprises:
sending the transaction information to the bank account corresponding to the user account when a sum of refund amounts in all the transaction information in the information set is higher than a lowest refund limit.

8. An apparatus comprising:
one or more processors;
memory;
a generation module stored in the memory and executable by the one or more processors to receive a transaction instruction from a user account and generate corresponding transaction information according to the transaction instruction;
a transaction account module stored in the memory and executable by the one or more processors to send the transaction information to a transaction account that is bound to the user account in advance and process the transaction information through the transaction account; and
a sending module stored in the memory and executable by the one or more processors to send the processed transaction information to the user account through the transaction account.

9. The apparatus of claim 8, wherein the transaction instruction comprises a refund instruction, the transaction information comprises refund information which includes one or more of a payment channel or a refund amount.

10. The apparatus of claim 8, wherein the sending module further determines whether the transaction information satisfies a preset condition, sends the transaction information to a bank account corresponding to the user account through the transaction account if affirmative, stores the transaction information in an information set and sends the transaction information to the bank account corresponding to the user account in response to a total amount associated with all transaction information in the information set satisfying the preset condition otherwise.

11. The apparatus of claim 10, wherein the sending module further determines whether a refund amount in the transaction information is higher than a lowest refund limit, and determines that the transaction information satisfies the preset condition in response to determining that the refund amount in the transaction information is higher than the lowest refund limit.

12. The apparatus of claim 10, wherein the sending module further determines a bank type of the bank account corresponding to the user account and stores the transaction information in an information set corresponding to the determined bank type in response to determining that the transaction information satisfies the preset condition.

13. The apparatus of claim 10, wherein the sending module stores the transaction information in an information set corresponding to the user account, and sends the transaction information to the bank account corresponding to the user account in response to a sum of a plurality of refund amounts included in all transaction information in the information set corresponding to the user account being higher than a lowest refund limit set up by a bank associated with the bank account.

14. One or more computer-readable media storing executable instructions that, when executed by one or more processors, cause the one or more processors to perform acts comprising:
receiving a transaction instruction from a user account and generating corresponding transaction information according to the transaction instruction;
sending the transaction information to a transaction account that is bound to the user account in advance and processing the transaction information through the transaction account; and
sending the processed transaction information to the user account through the transaction account.

15. The one or more computer-readable media of claim 14, wherein the transaction instruction comprises a refund instruction, the transaction information comprises refund information which includes one or more of a payment channel or a refund amount.

16. The one or more computer-readable media of claim 14, wherein sending the processed transaction information to the user account comprises:
determining whether the transaction information satisfies a preset condition;
sending the transaction information to a bank account corresponding to the user account through the transaction account in response to determining that the transaction information satisfies the preset condition; and
storing the transaction information in an information set, and sending the transaction information to the bank account corresponding to the user account when a total amount that is associated with all transaction information in the information set satisfies the preset condition, in response to determining that the transaction information does not satisfy the preset condition.

17. The one or more computer-readable media of claim 16, wherein the transaction instruction comprises a request for refund, and wherein determining whether the transaction information satisfies the preset condition comprises determining whether a refund amount in the transaction information is higher than a lowest refund limit.

18. The one or more computer-readable media of claim 16, wherein determining that the transaction information satisfies the preset condition in response to determining that the refund amount in the transaction information is higher than a lowest refund limit.

19. The one or more computer-readable media of claim 16, wherein storing the transaction information in the information set comprises:
determining a bank type of the bank account corresponding to the user account; and
storing the transaction information in a specified information set corresponding to the determined bank type.

20. The one or more computer-readable media of claim 19, wherein sending the transaction information to the bank account corresponding to the user account comprises sending the transaction information to the bank account corresponding to the user account when a sum of refund amounts in all the transaction information in the information set is higher than a lowest refund limit.
